(19) United States
(12) Patent Application Publication
(10) Pub. No.: US 2003/0034914 A1
(43) Pub. Date: Feb. 20, 2003

(54) System for location of mobile telephones by emergency call centers

(76) Inventor: Joshua Noah Schur, Chicago, IL (US)

Correspondence Address: Joshua Schur, 6144 N. ST. LOUIS AVENUE, CHICAGO, IL, 60659, US

(21) Appl. No.: 10/212,488

(22) Filed: Aug. 5, 2002

Related U.S. Application Data
(60) Provisional application No. 60/311,954, filed on Aug. 13, 2001.

(51) Int. Cl. G01S 5/14

(52) U.S. Cl. 342/357.1

(57) ABSTRACT

The present invention is directed to a telecommunications system that permits the precise location of mobile telephones by emergency call centers.

A mobile telephone is equipped with a GPS (Global Positioning System) device which can output data corresponding to the position of a mobile telephone. This GPS derived data is then inserted into the data packets which would otherwise carry voice data from the mobile telephone. The insertion of GPS data in place of voice data only occurs during very short intervals of time, so as not to significantly interfere with the transmission of the voice data. The data packets containing the GPS data are further encoded with additional binary digits so that they can be distinguished from data packets containing voice data.

The voice data and intermittently transmitted GPS data are thus received at an emergency call center during an emergency. The emergency call center is equipped to read the data packets and automatically look for packets containing the additional binary digits. These packets are then separated from the voice packets and decoded to determine the GPS data transmitted from the mobile telephone.

### SUMMARY OF THE INVENTION

The purpose of this invention is to assist emergency call centers, such as police call centers and 911 call centers in locating the position of a mobile telephone that is placing a 911 emergency call.

Presently, a caller placing an emergency 911 call on a mobile telephone must know where he or she is located in order to direct emergency crews to the scene of an emergency. If the caller does not know the exact location of the emergency, or cannot determine the exact location from road signs or landmarks, the emergency call is of no value since emergency crews will not know where to go to reach the energency.

Mobile telephones currently available to the public are programmed to transmit voice data in the form of standardized packets of data. These packets of data are obtained by converting samples of the caller's voice into binary code (1's and 0's) This is accomplished by sampling the caller's voice at rapid intervals and converting each sample into a voltage. The voltage is then converted into the binary code which gets packed into a standardized data packet.

The present invention takes advantage of this design by intermittently packing the packets of data with Global Positioning System (GPS) data instead of sampled voice data.

In order to maintain the clarity and integrity of a placed call, the data packets containing GPS data are only transmitted for 0.1 second intervals, spaced apart by 5 seconds of voice data.

### DETAILED DESCRIPTION OF THE INVENTION

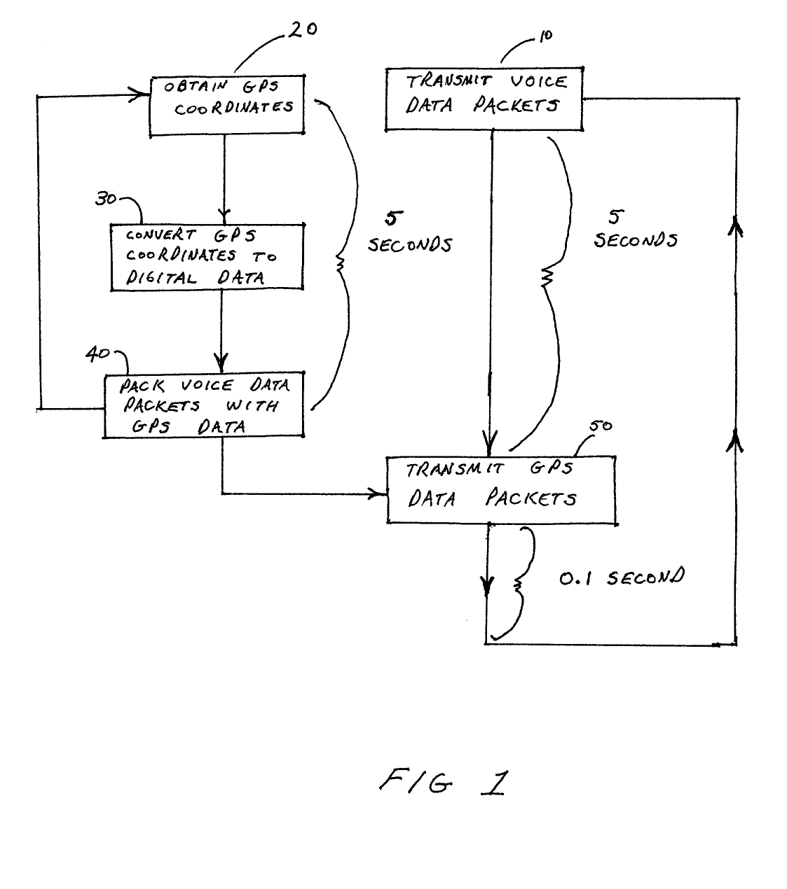

FIG. 1 provides a flow chart to understand the details of the present invention.

A mobile cellular telephone will transmit conventional voice data packets once the call has been set up and connected. This is illustrated at block 10. Call set up protocols, such as Signaling System 7 (SS7) are conventionally used to set up a telephone call with a mobile cellular telephone. During the transmission of the voice data packets, a Global Positioning System (GPS) locator carried directly upon the mobile cellular telephone will collect GPS data (block 20) so as to accurately identify the location of the mobile cellular telephone within approximately 50 yards. As seen in block 30, the GPS coordinates obtained from the GPS locator are converted into digital data. preferably in binary format resembling the voice data. The resulting digital data is then packed into the standard voice data packets (block 40) so that they can be transmitted by the mobile cellular phone to the called party (block 50).

In order for the called party telephone receiver to distinguish between voice data packets and GPS data packets, the GPS data packets may be packed with additional binary codes that provide an indication flag to indicate the presence of GPS data within the packet. For example, a string of binary code carrying GPS data can begin with the code “01” to indicate that the data packet contains GPS data instead of voice data. Similarly, voice data packets can be begin with the code “02” so that the packets are not confused with one another.

In order to avoid significant disruption to the call transmission, and to maintain call quality, the data packets containing the GPS data are transmitted in intervals of only 0.1 seconds, and separated by voice packet transmissions of 5 seconds. This will permit the transmission of sufficient voice data to maintain call clarity while permitting sufficient time interval to transmit the GPS data on the same transmission frequency.

In cases of emergency, the called party would be an emergency call center, such as a local 911 municipal call center. Software programmed into the call center would look for packets beginning with the special “01” code, indicating the presence of GPS data. These packets would be sent to separate computer program that would break down the packets and convert their binary data into GPS coordinates. These GPS coordinates would be the coordinates of the caller's telephone, since they were obtained by a GPS receiver physically carried by the caller's telephone.

Packets containing the “02” code would be processed normally, and produce the caller's voice at the call center.

Due to the usage of the special “01” and “02” codes, the voice data packets and GPS data packets would never be confused with one another. The timing of the data packet transmission outlined in FIG. 1 would also prevent the GPS and voice data packets from being sent simultaneously.

The present invention has significant advantages over conventional emergency reporting systems, which require that the caller actually know where he or she is located in order to direct emergency crews to the site of an emergency. In the instant invention, the caller does not need to know where he or she is located, since the location of the telephone itself is transmitted to the emergency call center. The present invention takes advantage of the existing features of cellular telephones so as to permit transmission of location information without significantly altering the structure or design of mobile telephones.

1. A system for locating a mobile telephone by an emergency call center, comprising:
a mobile telephone configured to transmit packets of data;
a GPS locator device attached to said mobile telephone;
means for inserting GPS data derived from said GPS locator device into said data packets at intermittent periods of time;
means for inserting supplemental binary codes into data packets containing GPS data so as to identify said data packets as containing GPS data;
means located at said emergency call center to receive and decode said data packets containing said supplementary binary codes and GPS data;
wherein said GPS data identifies the location of said mobile telephone to said emergency call center.
